(19) United States
(12) Patent Application Publication
(10) Pub. No.: US 2005/0193857 A1
(43) Pub. Date: Sep. 8, 2005

(54) Operation device

(75) Inventors: Minoru Sunadome, Kawagoe (JP); Kazuhiro Masamori, Kawagoe (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/050,436

(22) Filed: Feb. 4, 2005

(30) Foreign Application Priority Data
Feb. 4, 2004 (JP) 2004-28615

(51) Int. Cl. G05G 1/10

(52) U.S. Cl. 74/543

(57) ABSTRACT

The operation device 1 includes a body 12 of the operation device, operation shaft 11 and knob 6. The operation shaft 11 is supported by the body 12 oscillationally in multi-directions around one end 11a of the operation shaft. The body 12 includes a plurality of detection switches. The detection switch detects that the operation shaft 11 oscillates so as to allow the one end 11a comes in contact with the detection switch. The knob 6 is attached to the operation shaft 11. The knob 6 is provided with flat faces and ridgelines. The ridgeline is provided between the adjacent flat faces. The ridgeline is positioned between the adjacent detection switches. When the ridgeline abuts against the body 12, the ridgeline conducts the operation shaft 11 so that the flat face abuts against the body 12.

### BACKGROUND OF THE INVENTION

(1) Field of the Invention

The present invention relates to an operation device for carrying out various operation of electronic equipment such as navigation equipment and game equipment.

(2) Description of the Related Art

For example, navigation equipment (hereinafter, car navigation; see Japanese Patent Application Laid-Open No. H10-301485) as electronic equipment is mounted on an instrument panel of a motor vehicle as a mobile unit. The car navigation includes a display for displaying map data and so on; and an operation device for operating the displaying condition of the map data displayed on the display.

The operation device includes: a box-shaped body of the operation device; an operation shaft supported by the body oscillationally in multi-directions around an end of the operation shaft; and a plurality of detection switches as the detection means received in the body. A plurality of the detection switches, for example, eight detection switches are provided at the same intervals along the circumferential direction around the end of the operation shaft.

When the operation shaft oscillates relatively to the body of the operation device so that the end of the operation shaft approaches the detection switch, the detection switch detects that the end of the operation shaft comes in contact therewith. The end of the operation shaft enters into a fan-shaped detection range, the center of an arc of the fan being the end of the operation shaft, so that the end of the operation shaft comes in contact with the detection switch. The detection ranges of a plurality of the detection switches are formed not to leave a space therebetween and not to overlap with one another.

In addition, when the end of the operation shaft comes in contact with the detection switch, the detection switch detects that the operation shaft oscillates relatively to the body of the operation device, so that the opposite end of the operation shaft falls down toward the inside of the detection range. Further, the operation device detects a direction in which the operation shaft falls down relatively to the body of the operation device by detecting that an end of the operation shaft comes in contact with one of a plurality of the detection switches.

When the operation shaft oscillates relatively to the body of the operation device, the operation device detects that one of a plurality of the detection switches comes in contact with an end of the operation shaft. Then, the operation device outputs an information indicating the direction in which the operation shaft falls down to a display. Then the car navigation shifts a displayed area of the map data displayed by the display along the direction in which the operation shaft falls down.

By oscillating the operation shaft of the operation device relatively to the body of the operation device, for example, when eight detection switches are provided, the car navigation shifts the displayed area of the map data displayed by the display in eight directions such as upward, downward, leftward, rightward, upper-left direction and so on. By oscillating the operation shaft relatively to the body of the operation device, the car navigation displays on the display an extensive map data beyond a range that can be displayed on the display at one time.

With the conventional operation device that has been used in a car navigation, when the operation shaft is pushed down toward a boundary between the detection areas of the adjacent detection switches, the operation device detects that an end of the operation shaft comes in contact with one of the adjacent detection switches. Therefore, when the operation shaft is pushed down toward the boundary, a detection switch that the user does not intend might detects the contact, resulting in that the map data on the display might be shifted in a direction that the user does not intend.

### SUMMARY OF THE INVENTION

It is therefore an objective of the present invention to solve the above problem and to provide an operation device which enables that various electronic equipment is used in accordance with the user's intention.

In order to attain the above objective, the present invention is to provide an operation device including:
a body of the operation device;
an operation shaft supported by the body oscillationally in multi-directions around one end of the operation shaft;
a knob attached to an opposite end of the operation shaft; and
a plurality of detection devices for detecting that the operation shaft oscillates, the detection devices being provided in a circumferential direction around the one end of the operation shaft,
   wherein the knob is provided, with a control member for controlling a oscillating direction of the operation shaft, wherein when the operation shaft oscillates relatively to the body so that the one end of the operation shaft is positioned between the adjacent detection devices, the control member conducts the one end of the operation shaft to one of the detection devices.

### BRIEF DESCRIPTION OF THE DRAWINGS

FIG. 1 is a perspective view illustrating an outside appearance of a car navigation as electronic equipment to which an operation device according to a preferred embodiment of the present invention is to be attached;

FIG. 2 is a perspective view illustrating an operation device according to a preferred embodiment of the present invention;

FIG. 3 is an exploded perspective view of the operation device shown in FIG. 2;

FIG. 4 is a front view of a display of the car navigation shown in FIG. 1;

FIG. 5 is a front view of the operation device shown in FIG. 2;

FIG. 6 is a cross sectional view taken along a VI-VI line shown in FIG. 2;

FIG. 7 is a front view of a knob of the operation device shown in FIG. 2;

FIG. 8 is a side view of the knob shown in FIG. 7;

FIG. 9 is a rear view of the knob shown in FIG. 7;

FIG. 10 is a perspective view of the knob shown in FIG. 7 viewed from the rear;

FIG. 11 is another perspective view of the knob shown in FIG. 7 viewed from the rear;

FIG. 12 is a front view illustrating a state when an operation shaft of the operation device shown in FIG. 5 is pushed down so as to be positioned above a boundary;

FIG. 13 is a side view viewed from a direction of an arrow XIII shown in FIG. 12;

FIG. 14 is an enlarged side view of a part XIV shown in FIG. 13;

FIG. 15 is a cross sectional view taken along a XV-XV line shown in FIG. 12;

FIG. 16 is a front view illustrating a state when an operation shaft of the operation device shown in FIG. 12 is pushed down so as to be entered into a detection area of one side of the boundary;

FIG. 17 is a side view viewed from a direction of an arrow XVII shown in FIG. 16;

FIG. 18 is a cross sectional view taken along a XVIII-XVIII line shown in FIG. 16;

FIG. 19 is a side view of another example of a knob similarly to FIG. 8;

FIG. 20 is a rear view of the knob shown in FIG. 19; and

FIG. 21 is a perspective view of the knob shown in FIG. 19 viewed from the rear.

### DESCRIPTION OF THE PREFERRED EMBODIMENTS

In the operation device according to the present invention, when the operation shaft is pushed down (i.e. allowed to fall down) toward between the detection devices which are adjacent to each other, the control member controls the oscillating direction of the operation shaft so as to conduct the one end of the operation shaft to one of the detection devices. Thus, when the operation shaft is pushed down toward between the adjacent detection devices, one of the detection devices securely detects that the operation shaft is pushed down. That is, when the operation shaft is pushed down toward between the adjacent detection devices so that the operation shaft is positioned between the adjacent detection devices, it is prevented from occurring that the detection device that the user does not intend detects the oscillation of the operation shaft.

The control member may includes a plurality of projections, which project from the knob attached to the opposite end of the operation shaft toward the body of the operation device, that is, toward the one end of the operation shaft, extend radially around the opposite end of the operation shaft, and are positioned between the adjacent detecting devices.

Further, the control member may be a ridgeline occurring between adjacent flat faces, wherein the flat faces correspond to the respective detecting devices and are inclined in a direction gradually leaving from the body of the operation device as approaching toward the outside of the knob.

Further, the control member may be a rib that projects from the knob toward the body of the operation device.

### EXAMPLES

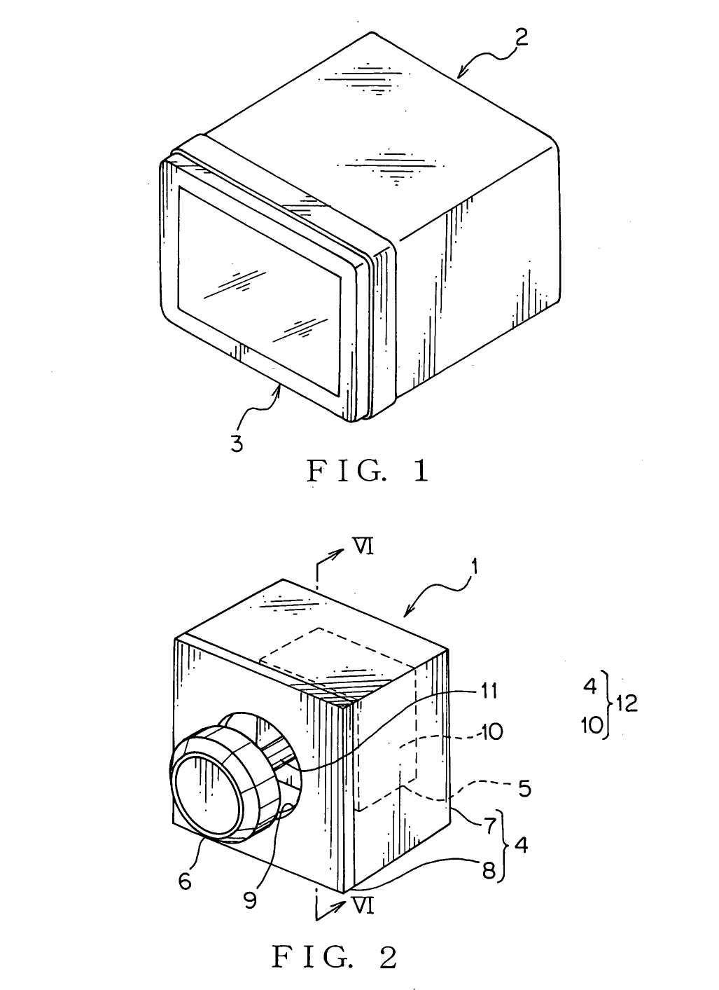

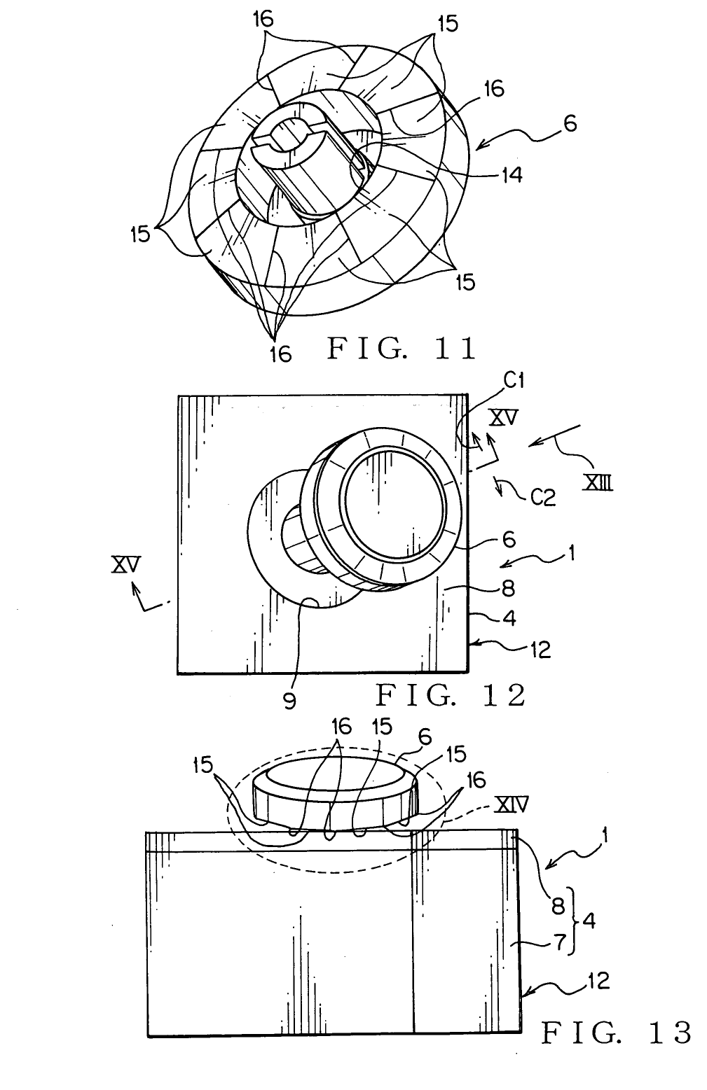

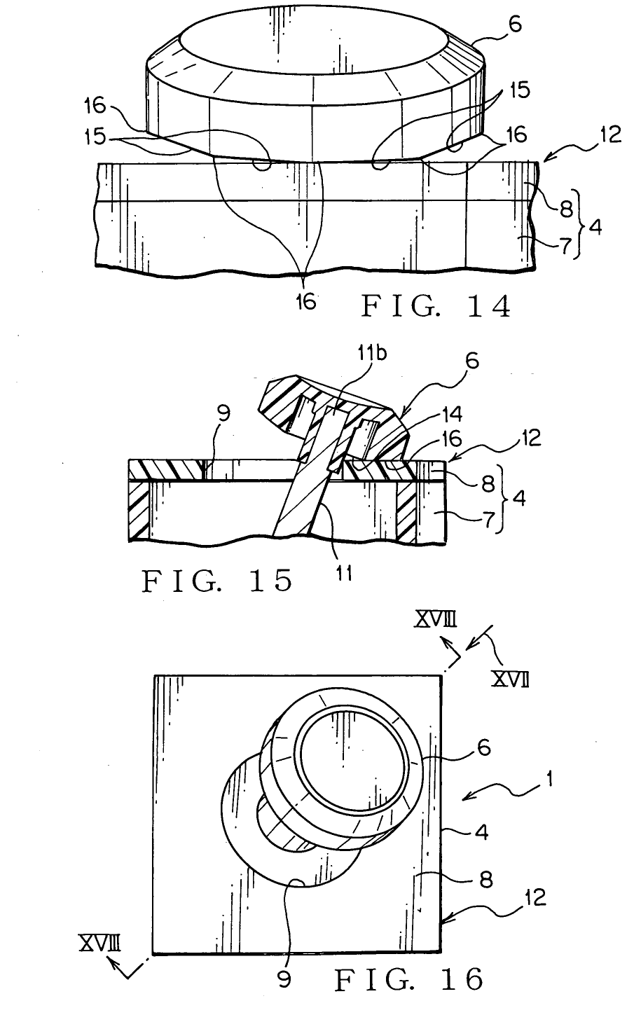

In the following, an operation device according to a preferred embodiment of the present invention will be explained with reference to FIGS. 1-18. The operation device 1 shown in FIG. 2 is attached to a navigation device 2 (hereinafter, car navigation) shown in FIG. 1 to be mounted on an instrument panel of a motor vehicle as a mobile unit. The car navigation 2 is the electronic equipment described in this specification.

As shown in FIG. 1, the car navigation 2 includes a display 3. As shown in FIG. 4, the display 3 displays map data A and so on. The operation device 1 shifts a display area of the map data A displayed on the display 3 in eight directions such as upward, downward, leftward, rightward, upper-left direction and so on. The operation device 1 shifts the displayed area of the map data A toward the eight directions on the display, thereby displaying on the display 3 an extensive map data A beyond a range that can be displayed on the display 3 at one time. Thus, the operation device 1 is used for carrying out various operations of electronic equipment such as the car navigation 2.

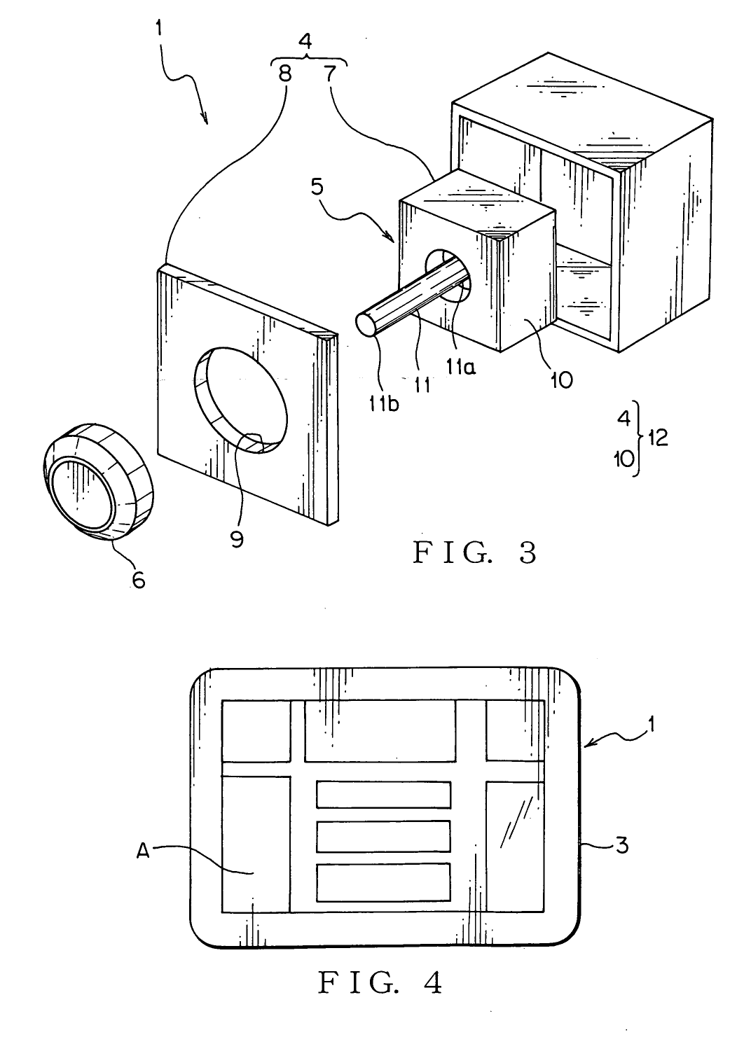

As shown in FIGS. 2 and 3, the operation device 1 includes a cover 4, joystick 5 and knob 6. The cover 4 includes a cylindrical lower cover 7 having a bottom and a flat plate-shaped upper cover 8. The lower cover receives a support part 10 (explained later on) of the joystick 5. A round through hole 9 is provided at the center of the upper cover 8. The hole 9 guides an operation shaft 11 (explained later on) therethrough. The lower cover 7 receives the support part 10 and the hole 9 guides the operation shaft 11 therethrough, thereby the lower cover 7 and upper cover 8 are fixed to each other. The cover 4 receives the support part 10 of the joystick 5 therein when the lower cover 7 and upper cover 8 are fixed to each other.

As shown in FIGS. 2 and 3, the joystick 5 includes the box-shaped support part 10 and rod-shaped operation shaft 11. The support part 10 is formed in a rectangular parallelepiped-shape. The support part 10 and cover 4 constitute the body 12 of the operation device 1 as described in this specification.

One end 11a of the operation shaft 11 is received in the support part 10 while an opposite end 11b of the operation shaft 11 projects from the support part 10. The opposite end 11b of the operation shaft 11 is exposed outside of the cover 4, that is, outside of the body 12. The operation shaft 11 is supported by the support part 10 oscillationally in multi-directions around the one end 11a of the operation shaft 11. That is, the operation shaft 11 is supported by the body 12 oscillationally in multi-directions around the one end 11a of the operation shaft 11.

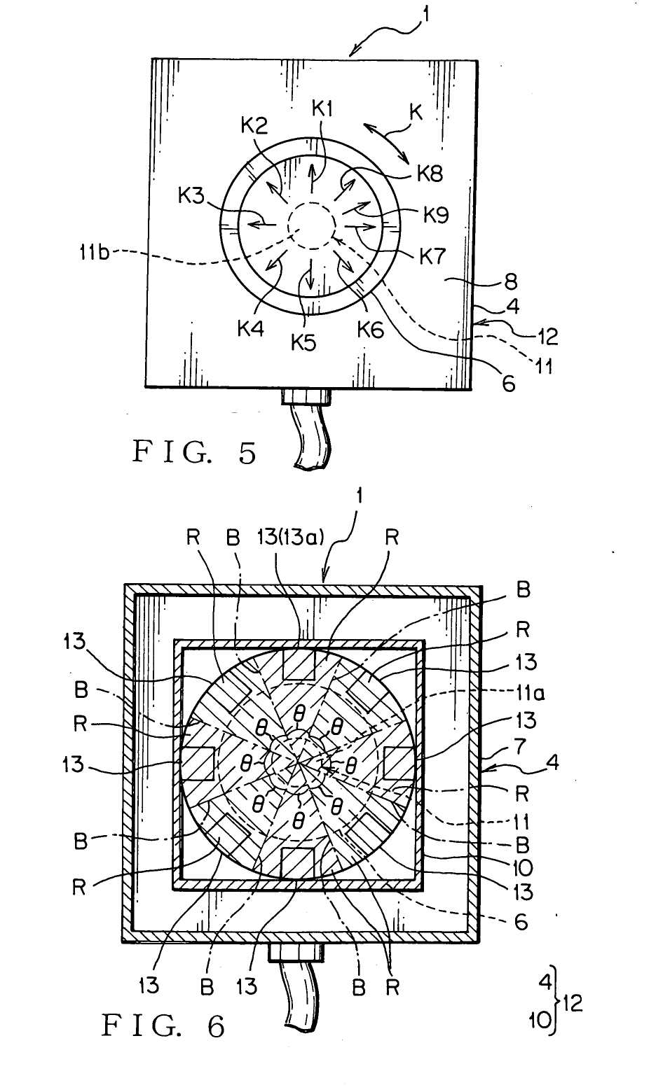

Therefore, as shown in FIG. 5, the operation shaft 11 is set oscillationally along respective arrows K1-K8 (i.e. in multi-directions) around the one end 11a relatively to the support part 10. As shown in FIGS. 12 and 16, the operation shaft 11 is rotatable along an arrow K shown in FIG. 5, being oscillational relatively to the support part 10 around the one end 11a being pushed down relatively to the support part 10. Further, the operation shaft 11 is oscillational relatively to the support part 10 around the one end 11a in any direction between the arrows K1-K8.

Further, the operation shaft 11 is biased into a condition (shown in FIG. 2) along a direction crossing at right angles with an upper face of the support part 10 by biasing means (not shown in the figure). On a condition that the longitudinal direction shown in FIG. 2 crosses at right angles with the upper face of the support part 10, the operation shaft 11 is not pushed down (i.e. not oscillating) relatively to the support part 10. The position of the operation shaft 11 and knob 6 shown in FIG. 2 is hereinafter called a neutral position. At the neutral position, the one end 11a of the operation shaft 11 does not come in contact with any detection switch 13.

As shown in FIG. 6, a plurality of the detection switches 13 as the detection devices are received in the support part 10. That is, the operation device 1 includes a plurality of the detection switches 13. As shown in FIG. 6, the detection switches 13 are arranged at the same intervals along the circumferential direction around the one end 11a of the operation shaft 11. When the operation shaft 11 oscillates relatively to the support part 10 so that the one end 11a of the operation shaft 11 enters in a detection area shown with a parallel diagonal lines in FIG. 6, the one end 11a comes in contact with the detection switch 13. When the one end 11a comes in contact with the detection switch 13, the detection switch 13 detects that the operation shaft 11 has oscillated.

Thus, when the one end 11a of the operation shaft 11 approaches the detection switch 13, the detection switch 13 detects that the one end 11a comes in contact with the detection switch 13. When detection switch 13 detects that the one end 11a comes in contact with the detection switch 13, that is, when detection switch 13 detects that the one end 11a has entered into the detection area R, detection switch 13 outputs this information to the display 3, that is, to the car navigation 2. Then, the display 3 shifts the map information A in response to the information. When the detection switch 13 located highest in FIG. 6 (hereinafter, 13a) detects that the one end 11a comes in contact with the detection switch 13a, the display 3 shifts the map information A upward in FIG. 4.

The detection area R of each detection switch 13 is formed in a fan-shape, the fan being around the axis of the operation shaft, that is, around the one end 11a. In the example shown in the figure, eight detection switches 13 are provided, therefore the center angle θ of the detection area R of each detection switch 13 is 45°.

A plurality of the detection areas R are arranged without having any distance therebetween and without overlapping with each other. Consequently, when the operation shaft 11 oscillates relatively to the support part 10 from the neutral position, the one end 11a of the operation shaft 11 comes in contact with one detection switch 13 of a plurality of the detection switches 13. Further, there is formed a boundary B shown with a alternate long and short dash line in FIG. 6 between the detection areas R which are adjacent to each other. The boundary B is formed between the all detection areas R which are adjacent to each other. Each boundary B extends radially from the center axis of the operation shaft 11, i.e. from the one end 11a.

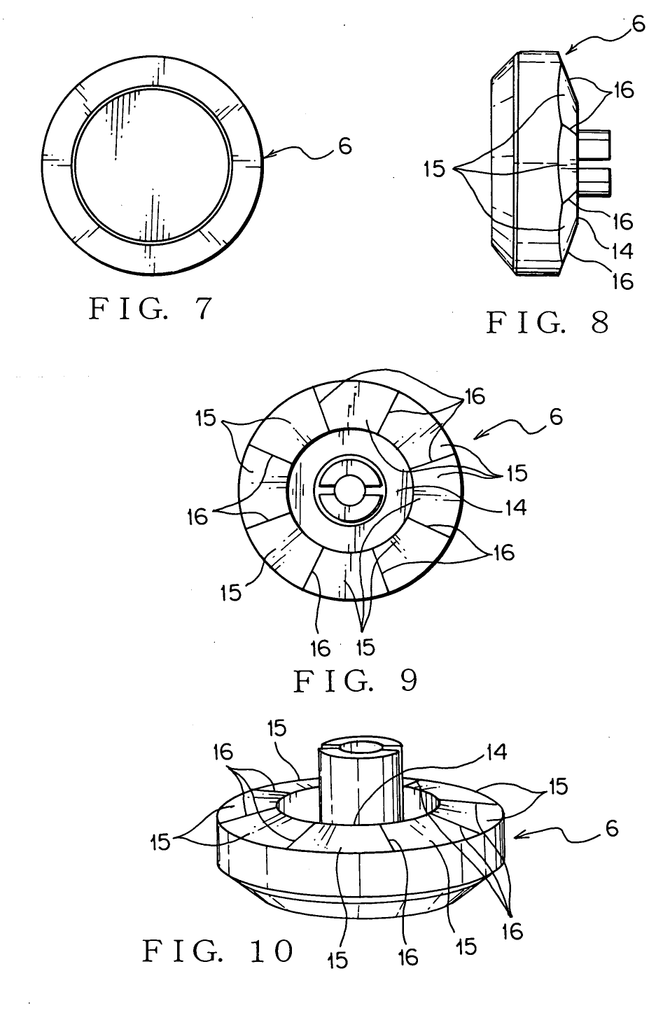

As shown in FIGS. 7-11, the knob 6 is formed in a disk-shape and attached to the opposite end 11b of the operation shaft 11. The outer diameter of the knob 6 is substantially larger than that of the operation shaft 11. The knob 6 is attached to the operation shaft 11 being aligned therewith.

As shown in FIGS. 8-11, a plurality of flat faces 15 are formed on a back surface 14 of the knob 6, which back surface 14 faces the one end 11a of the operation shaft 11, that is, faces the support part 10. Each flat face 15 is formed on the outer edge of the knob 6. A plurality of the flat faces 15 are arranged in the circumferential direction around the opposite end 11b of the operation shaft 11. The number of the flat faces 15 is equal to the number of the detection switches 13. The shape of each flat face 15 is the same as that of each detection switch 13. In the example shown in the figure, eight flat faces 15 are provided.

When the support part 10 of the joystick 5 is received in the cover 4 and the knob 6 is attached to the operation shaft 11, the flat face 15 is arranged in line with the detection area R along the longitudinal direction of the operation shaft 11 located at the neutral position. Here, to be arranged along the longitudinal direction of the operation shaft 11 located at the neutral position means to be positioned correspondingly, that is, correspondingly to the respective detection devices. That is, the flat faces 15 are provided being positioned correspondingly to the respective detection devices 13.

Thus, the flat face 15 is arranged being positioned correspondingly to the corresponding detection area R. Further, in a state that the operation shaft 11 is located at the neutral position, the flat face 15 is inclined in a direction in which the flat face 15 gradually leaves from the support part 10, that is, from the opposite end 11b of the operation shaft 11 as the flat face 15 approaches toward the outer edge of the knob 6.

Therefore, each ridgeline 16 as a control member is formed between the flat faces 15 which are adjacent to each other. The ridgeline 16 projects from the flat face 15 toward the-support part 10, that is, toward the one end 11a of the operation shaft 11. Further, the ridgeline 16 is arranged in line with the boundary B along the longitudinal direction of the operation shaft 11 located at the neutral position. That is, the ridgeline 16 corresponds to the boundary B and is positioned between the adjacent detection switches 13. Further, a plurality of the ridgelines 16 extend radially from the opposite end 11b of the operation shaft 11. The ridgeline 16 is the projection. That is, the operation device 1 includes a plurality of ridgelines 16 as the projections.

As for the operation device 1, the support part 10 is received in the lower cover 7 and the operation shaft 11 is guided through the hole 9 so as to fix the power cover 7 to the upper cover 8. Then, the knob 6 is attached to the opposite end 11b of the operation shaft 11.

When the car navigation is operated, that is, when the map data to be displayed on the display 3 is shifted by using the operation device 1, the operation shaft 11 is pushed down in the direction in which the user wants to shift the map data A. Then, the one end 11a of the operation shaft 11 comes in contact with the detection switch 13 that corresponds to the direction in which the operation shaft is pushed down, so that the map data A displayed on the display 3 is shifted in response to the direction in which the operation shaft 11 is pushed down.

For example, when the user wants to shift the map data A to be displayed upward in FIG. 6, the knob 6 is shifted (or pushed down) upward in FIG. 5 along the arrow K1 in FIG. 5. Then, the detection switch 13a located highest in FIG. 6 detects that the one end 11a comes in contact with the detection switch 13a and outputs this information to the car navigation 2, that is, to the display 13. Then, the map data A displayed on the display 3 is shifted upward.

Further, as shown in FIG. 12, when the operation shaft 11 is pushed down (or oscillated) along the arrow K9 situated between the arrows K7 and K8 shown in FIG. 5, as shown in FIGS. 13-15, the ridgeline 16 comes in contact with the upper cover 8. That is, the pushed-down (or oscillated) operation shaft 11 is located on the boundary B, that is, located between the adjacent detection switches 13. At this time, since the ridgeline 16 projects from the flat face 15 toward the support part 10 and provided between the adjacent flat faces 15, when the operation shaft 11 is further pushed down, that is, when the knob 6 is further pressed toward the upper cover 8, the knob 6 is shifted in the direction of an arrow C1 or C2 shown in FIG. 12, that is, the operation shaft 11 is shifted in the direction of an arrow Cl or C2 shown in FIG. 12.

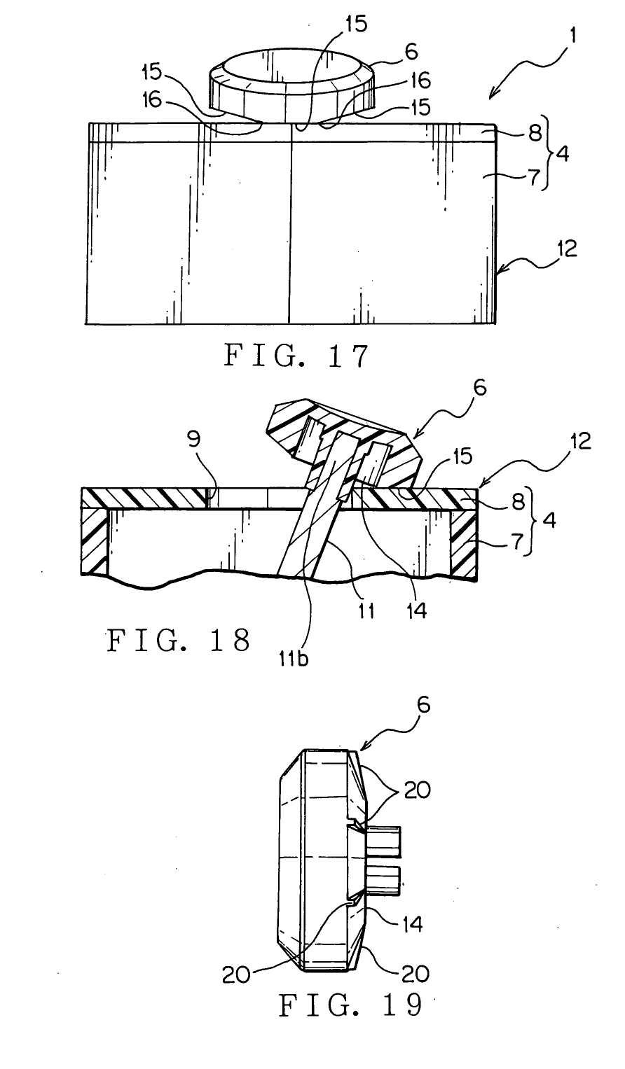

That is, the knob 6 (or the operation shaft 11) is moved so that the flat face 15 comes in contact (or overlaps) with the upper cover 8. For example, when the operation shaft 11 is moved in the direction of the arrow C1 shown in FIG. 12, the operation shaft 11 is positioned at a position shown in FIG. 16. At this time, as shown in FIGS. 17 and 18, the flat face 15 adjacent to the ridgeline 16 that comes in contact with the upper cover 8 comes in contact (or overlaps) with the upper cover 8 (or the body 12). Then, the one end 11a comes in contact with the detection switch 13 that corresponds to the position at which the operation shaft 11 is pushed down, so that the map data A displayed on the display 3 is shifted.

Thus, when the one end 11a of the operation shaft 11 is positioned on the boundary B between the detection areas R of the adjacent detection switches 13, the ridgeline 16 as the control member conducts the operation shaft 11 in such a manner that the one end 11a of the operation shaft 11 is entered into one of two detection areas R of the adjacent detection switches. Further, when the operation shaft 11 is positioned between the adjacent detection switches 13, the ridgeline 16 as the control member conducts the one end 11a to one of the adjacent detection switches 13. Further, the ridgeline 16 as the control member conducts the operation shaft 11 to so that one of the flat faces 15 that position the ridgeline 16 therebetween comes in contact (or overlaps) with the upper cover 8. Thus, the ridgeline 16 as the control member controls the oscillating direction of the operation shaft 11.

According to the preferred embodiment, when the operation shaft 11 is pushed down toward between the adjacent detection switches 13, the ridgeline 16 as the control member controls the oscillating direction of the operation shaft 11 so that the one end 11a comes in contact with one of the detection switches 13. Therefore, when the operation shaft 11 is pushed down toward between the adjacent detection switches 13, one of the adjacent detection switches 13 can securely detects that the one end 11a of the operation shaft 11 comes in contact with said one.

That is, when the operation shaft 11 is pushed down toward between the adjacent detection switches 13, it can be prevented that the operation-shaft 11 is positioned between the adjacent detection switches 13 so that the one end 11a of the operation shaft 11 comes in contact with the operation switch 13 that the user does not intend. That is, it is prevented that the map data A is shifted in a direction in which the user does not intend. Therefore, by oscillating (or by pushing down) the operation shaft 11 of the joystick 5 relatively to the support part 10, the one end 11a of the operation shaft 11 can be allowed to come in contact with the detection switch 13 that the user intends and therefore, various electronic equipment such as the car navigation 2 can be used as the user intends.

Further, the ridgeline 16 is formed between the adjacent flat faces 15. The flat face 15 corresponds to the detection switch 13 and is inclined in a direction in which the flat face 15 gradually leaves from the support part 10 as the flat face 15 approaches toward the outer edge of the knob 6. Therefore, the ridgeline 16 projects from the flat face 15 toward the support part 10, that is, toward the one end 11a of the operation shaft 11.

The ridgeline 16 extends radially from the opposite end 11b of the operation shaft 11 and is positioned between the adjacent detection switches 13. Therefore, when the operation shaft 11 is pushed down toward between the adjacent detection switches 13, the ridgeline 16 is positioned between the adjacent detection switches 13 so as to come in contact with the upper cover 8. Therefore, when the operation shaft 11 is further pushed down in a state that the ridgeline 16 comes in contact with the upper cover 8, the operation shaft 11 falls down so that the flat face 15 adjacent to the ridgeline 16 that comes in contact with the upper cover 8 approaches toward the upper cover 8.

Therefore, when the operation shaft 11 is pushed down toward between the adjacent detection switches 13, it can be securely prevented that the operation shaft 11 is positioned between the adjacent detection switches 13 so that the one end 11a of the operation shaft 11 comes in contact with the operation switch 13 that the user does not intend. That is, it is prevented that the map data A is shifted in a direction in which the user does not intend. Therefore, various electronic equipment such as the car navigation 2 can be used as the user intends.

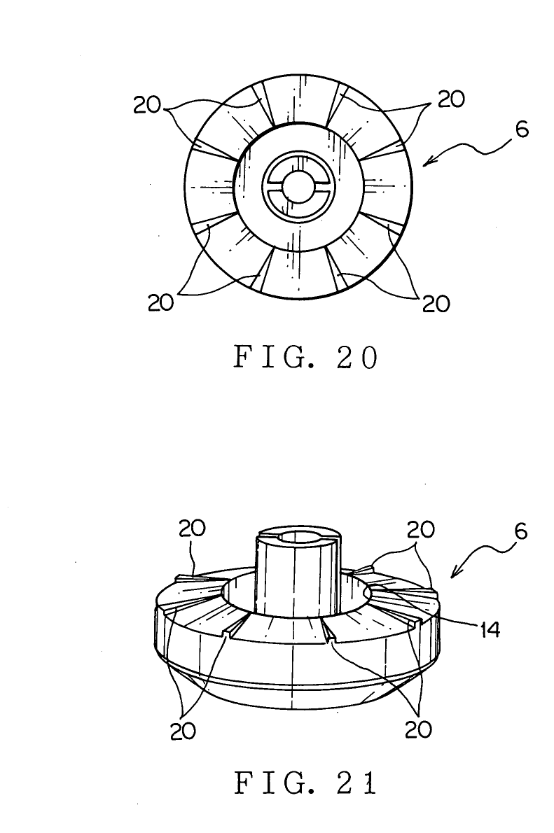

In the preferred embodiment described above, in a state that the knob 6 and operation shaft 11 is positioned at the neutral position, when the operation shaft 11 is pushed down so as to be positioned between the adjacent detection switches 13 with the aid of the ridgeline 16, which is formed between the flat faces 15 provided at positions corresponding to the respective detection switches 13, the operation shaft 11 is conducted so that the one end 11a comes in contact with one of the detection switches 13. However, as shown in FIGS. 19-21, ribs 20 may be provided as the control member instead of the ridgelines 16.

The rib 20 projects from a back surface 14 that faces to the support part 10 of the knob 6 or to the one end 11a of the operation shaft 11 toward the one end 11a of the operation shaft 11. That is, the rib 20 projects from the knob 6 toward the one end 11a of the operation shaft 11. Each rib 20 has a straight shape and is positioned between the adjacent detection switches 13 in a state that the knob 6 and operation shaft 11 is located at the neutral position. That is, the ribs 20 are in line with the boundaries B along the longitudinal direction of the operation shaft 11 at the neutral position. Further, a plurality of the ribs 20 extend radially from the opposite end 11b of the operation shaft 11. The rib 20 is the projection.

In a case shown in FIGS. 19-21, similarly to the preferred embodiment described hereinbefore, when the operation shaft 11 is pushed down toward between the adjacent detection switches 13, the rib 20 is placed above a position which overlaps with the boundary B so as to come in contact with the upper cover 8. When the operation shaft 11 is further pushed down on the condition that the rib 20 comes in contact with the upper cover 8, the operation shaft 11 is pushed down in such a manner that a neighbor (i.e. one side) of the rib 20 approaches toward the upper cover 8.

Accordingly, when the operation shaft 11 is pushed down toward between the adjacent detection switches 13 and the operation switch 11 is located between the adjacent detection switches 13, the one end 11a of the operation shaft 11 can be securely prevented from coming in contact with the detection switch 13 that the user does not intend. That is, the map data A can be securely prevented from shifting toward a direction that the user does not intend. That is, various electronic equipment such as the car navigation 2 can securely be used in a manner that the user intends to do.

In the above preferred embodiment, the operation device 1 is used to operate the car navigation 2 as the electronic equipment. However, the operation device 1 of the present invention may be used to operate various electronic equipment such as a game device and so on.

The aforementioned preferred embodiments are described to aid in understanding the present invention and variations may be made by one skilled in the art without departing from the spirit and scope of the present invention.

According to the preferred embodiments described above, the following operation device 1 can be obtained.

(Item 1) An operation device 1 including:
a body 12 of the operation device 1;
an operation shaft 11 supported by the body 12 oscillationally in multi-directions around one end 11a of the operation shaft 11;
a knob 6 attached to an opposite end 11b of the operation shaft 11; and
a plurality of detection switches 13 for detecting that the operation shaft 11 oscillates, the detection switches 13 being provided in a circumferential direction around the one end 11a of the operation shaft 11,
   wherein the knob 6 is provided with a control member 16, 20 for controlling a oscillating direction of the operation shaft 11, wherein when the operation shaft 11 oscillates relatively to the body 12 so that the one end 11a of the operation shaft 11 is positioned between the adjacent detection switches 13, the control member 16, 20 conducts the one end 11a of the operation shaft 11 to one of the detection switches 13.

(Item 2) The operation device 1 according to the Item 1, wherein the control member consists of a plurality of projections 16, 20, the projections 16, 20 projecting from the knob 6 toward the body 12 of the operation device 1, extending radially around the opposite end 11b of the operation shaft 11, and being positioned between the adjacent detection, switches 13.

(Item 3) The operation device 1 according to the Item 2, wherein the knob 6 is provided with a plurality of flat faces 15, the flat faces 15 facing to the body 12 of the operation device 1 and being positioned correspondingly to the respective detection switches 13, and being inclined in a direction leaving gradually from the body 12 of the operation device 1 as approaching toward an outer edge of the knob 6, wherein the projection 16 is a ridgeline 16 occurring between the adjacent flat faces 15.

(Item 4) The operation device according to the Item 2, wherein the projection 20 is a rib 20 projecting from the knob 6 toward the body 12 of the operation device 1.

According to the operation device 1 defined in Item 1, when the operation shaft 11 is pushed down toward between the adjacent detection switches 13, the control member 16, 20 controls the oscillating direction of the operation shaft 11 so that one of the detection switches 13 detects the oscillation of the operation shaft 11. Accordingly, when the operation shaft 11 is pushed down toward between the adjacent detection switches 13, one of the adjacent detection switches 13 can securely detect that the operation shaft 11 has oscillated.

Accordingly, when the operation shaft 11 is pushed down toward between the adjacent detection switches 13 and the operation switch 11 is located between the adjacent detection switches 13, it can be securely prevented from occurring that the detection switch 13 that the user does not intend detects the oscillation of the operation shaft 11. That is, by oscillating (i.e. pushing down) the operation shaft 11 relatively to the body 12 of the operation device 1, the desired detection switch 13 can be allowed to detect the oscillation of the operation shaft 11, so that various electronic equipment such as the car navigation 2 can be used in a manner that the user intends to do.

According to the operation device 1 defined in Item 2, the control member is a plurality of projections 16, 20, wherein the projections 16, 20 project from the knob 6 toward the body 12 of the operation device 1, i.e. toward the one end 11a of the operation shaft 11, extend radially around the opposite end 11b of the operation shaft 11, and are positioned between the adjacent detection switches 13. Accordingly, when the operation shaft 11 is pushed down toward between the adjacent detection switches 13, the projections 16, 20 come in contact with the body 12 of the operation device 1 and are placed at an overlapping position between the adjacent detection switches 13. Therefore, when the operation shaft 11 is further pushed down on the condition that the projection 16, 20 comes in contact with the body 12 of the operation device 1, the operation shaft 11 falls down in such a manner that one side of the projection 16, 20 that comes in contact with the body 12 approaches toward the body 12 of the operation device 1.

Accordingly, when the operation shaft 11 is pushed down toward between the adjacent detection switches 13 and the operation switch 11 is located between the adjacent detection switches 13, it can be securely prevented from occurring that the detection switch 13 that the user does not intend detects the oscillation of the operation shaft 11. That is, various electronic equipment such as the car navigation 2 can be used in a manner that the user intends to do.

According to the operation device 1 defined in Item 3, the projection is a ridgeline 16 occurring between the adjacent flat faces 15. The flat faces 15 are positioned correspondingly to the respective detection switches 13 and inclined in a direction leaving gradually from the body 12 of the operation device 1 as approaching toward an outer edge of the knob 6. When the operation shaft 11 is pushed down toward between the adjacent detection switches 13, after the ridgeline 16 comes in contact with the body 12 of the operation device 1, if the operation shaft 11 is further pushed down, the operation shaft 11 falls down in such a manner that one of the flat faces 15, which positions the ridgeline 16 that comes in contact with the body 12 therebetween, comes in contact with the body 12.

Accordingly, when the operation shaft 11 is pushed down toward between the adjacent detection switches 13 and the operation switch 11 is located between the adjacent detection switches 13, it can be securely prevented from occurring that the detection switch 13 that the user does not intend detects the oscillation of the operation shaft 11. That is, various electronic equipment such as the car navigation 2 can be used in a manner that the user intends to do.

According to the operation device 1 defined in Item 4, the projection is a rib 20 projecting from the knob 6 toward the body 12 of the operation device 1. Therefore, when the operation shaft 11 is pushed down toward between the adjacent detection switches 13, after the rib 20 comes in contact with the body 12 of the operation device 1, if the operation shaft 11 is further pushed down, the operation shaft 11 falls down in such a manner that one side of the rib 20, which comes in contact with the body 12 of the operation device 1, approaches toward the body 12.

Accordingly, when the operation shaft 11 is pushed down toward between the adjacent detection switches 13 and the operation switch 11 is located between the adjacent detection switches 13, it can be securely prevented from occurring that the detection switch 13 that the user does not intend detects the oscillation of the operation shaft 11. That is, various electronic equipment such as the car navigation 2 can be used in a manner that the user intends to do.

Incidentally, the contents of Japanese Patent Application No. 2004-28615 are hereby incorporated by reference.

1. An operation device comprising:
a body of the operation device;
an operation shaft supported by the body oscillationally in multi-directions around one end of the operation shaft;
a knob attached to an opposite end of the operation shaft; and
a plurality of detection devices for detecting that the operation shaft oscillates, the detection devices being provided in a circumferential direction around the one end of the operation shaft,
wherein the knob is provided with a control member for controlling a oscillating direction of the operation shaft, wherein when the operation shaft oscillates relatively to the body so that the one end of the operation shaft is positioned between the adjacent detection devices, the control member conducts the one end of the operation shaft to one of the detection devices.

2. The operation device according to claim 1, wherein the control member consists of a plurality of projections, said projections projecting from the knob toward the body of the operation device, extending radially around the opposite end of the operation shaft, and being positioned between the adjacent detection devices.

3. The operation device according to claim 2, wherein the knob is provided with a plurality of flat faces, said flat faces facing to the body of the operation device and being positioned correspondingly to the respective detection devices, and being inclined in a direction leaving gradually from the body of the operation device as approaching toward an outer edge of the knob, wherein the projection is a ridgeline occurring between the adjacent flat faces.

4. The operation device according to claim 2, wherein the projection is a rib projecting from the knob toward the body of the operation device.
